(19) United States
(12) Patent Application Publication
(10) Pub. No.: US 2012/0164528 A1
(43) Pub. Date: Jun. 28, 2012

(54) Composite anode with an interfacial film and lithium secondary battery employing the same

(75) Inventors: WANLI XU, BATON ROUGE, LA (US); JOHN C. FLAKE, BATON ROUGE, LA (US)

(73) Assignee: ELECTROCHEMICAL MATERIALS, LLC, BATON ROUGE, LA (US)

(21) Appl. No.: 13/363,587

(22) Filed: Feb. 1, 2012

(51) Int. Cl. H01M 4/64; H01M 4/505; H01M 10/052; H01M 4/583; H01M 4/38; H01M 4/62; H01M 4/485

(52) U.S. Cl. 429/211; 429/224; 429/231.3; 429/231.95; 429/231.8; 429/218.1

(57) ABSTRACT

A composite anode for lithium secondary battery which has an active anode material layer formed on a conductive substrate and an interfacial film coated on the active anode material layer, wherein the active anode material layer includes carbonaceous materials, other active and inactive materials, and a binder. The anode increases degree of the anode active material utilization and the cycle life and characteristic and capacity of the battery can be improved.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates to a composite anode having an interfacial film and a lithium secondary battery employing the anode, and more particularly, to an anode having an interfacial film coated thereon and a lithium secondary battery employing the anode, which has improved cycle life and battery capacity characteristics.

2. Description of the Related Art

Rapid development of portable electronic devices and electrical vehicles has led to an increasing demand for lighter, smaller secondary batteries with high energy and powder density. Among the currently developing batteries satisfying such requirements, lithium in battery is one of the most promising batteries in view of its relatively high energy and power density.

As such a secondary battery, there has been proposed various lithium ion batteries. In these batteries, a carbonaceous anode material has been adopted conventionally, such as graphite which is capable of intercalating and disintercalating lithium ions reversibly for lithium storage. Many of these batteries have been developed and commercialized. Among these batteries, however, the theoretical maximum lithium can be intercalated in carbon is limited to 1 lithium atom per 6 carbon atoms. Further, mechanical failure has been commonly observed for graphite anodes after prolonged cycle caused by reversible lithium intercalation and other side reactions with electrolyte.

U.S. Pat. No. 6,733,923 discloses a method of coating porous metal film on electrode surface can remarkably improve the capacity of a battery, high rate charging and discharging characteristics and a durability characteristic. U.S. Pat. No. 6,780,541 also disclosed that carbon electrode coated with a porous metal film also improves battery capacities and charging and discharging characteristics.

U.S. Pat. No. 7,078,124 discloses that coating positive electrode with a polymer layer can increase degree of the positive active material utilization, the cycle life characteristics and capacity of the battery can be improved, and swelling of the positive electrode of the lithium-sulfur battery can be reduced.

Aiming at eliminating the problems found in conventional secondary lithium batteries, the inventors have proposed a secondary lithium ion battery having an anode coated by a polymer film capable of allowing lithium ions to pass through as well as protect the anode from mechanical failure, and this secondary lithium battery has an improved charge and discharging cycle life.

### SUMMARY OF THE INVENTION

In one embodiment of the present invention, a composite anode comprising an anode active material layer and an interfacial film coated on its surface.

In another embodiment of the present invention, an anode active material layer comprising anode active materials, inactive materials, and a binder.

In yet another embodiment of the present invention, a method that creates the interfacial layer on the silicon composite anode surface.

In still another embodiment of the present invention, a lithium ion secondary battery includes the anode, a cathode, a separator, and a non-aqueous electrolyte.

### BRIEF DESCRIPTION OF THE DRAWING

The invention may be more completely understood in consideration of the detailed description of various embodiments of the invention that follows in connection with the accompany drawings, in which:

FIG. 1 shows a sketch of an example anode for lithium ion battery comprising an anode active material layer comprising silicon particles, carbonaceous materials, and a binder; and an interfacial film covering the anode surface.

FIG. 2 shows a graph of the charge and discharge capacities versus cycle number for an example anode.

While the invention is amenable to various modifications and alternative forms, examples thereof have been shown by way of example in the drawing and will be described in detail. It should be understood, however, that the intention is not to limit the invention to the particular embodiments shown and/or described. The intention is to cover all modifications, equivalents, and alternatives falling within the spirit and scope of the invention.

### DETAILED DESCRIPTION OF THE INVENTION

The present invention is believed to be applicable to a variety of different types of lithium secondary batteries and devices and arrangement involving silicon composite electrodes. While the present invention is not necessarily limited, various aspects of the invention may be appreciated through a discussion of examples using the context.

According to one embodiment of the present invention, a composite anode, comprising: an anode active material layer comprising at least one active material selected from the group consisting of carbon, silicon, germanium, tin, indium, gallium, aluminum, and boron; and an interfacial film coated on the anode active material layer.

In one embodiment, the interfacial film formed on the composite anode is a polymer layer composed of 10 to 100000 monomers, with a more preferred composition of 100 to 10000 monomers. The monomer includes 1 to 20 functional groups per molecule and the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, an aryloxy group, or combinations thereof. The interfacial film has a thickness of 0.5 to 50 .mu.m, with a more preferred thickness of 1 to 10 .mu.m.

In another embodiment, the interfacial film on the composite anode is a layer of ligands directed bonded with the active anode layer surface. The ligands include 1 to 20 functional groups per molecule and the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, an aryloxy group.

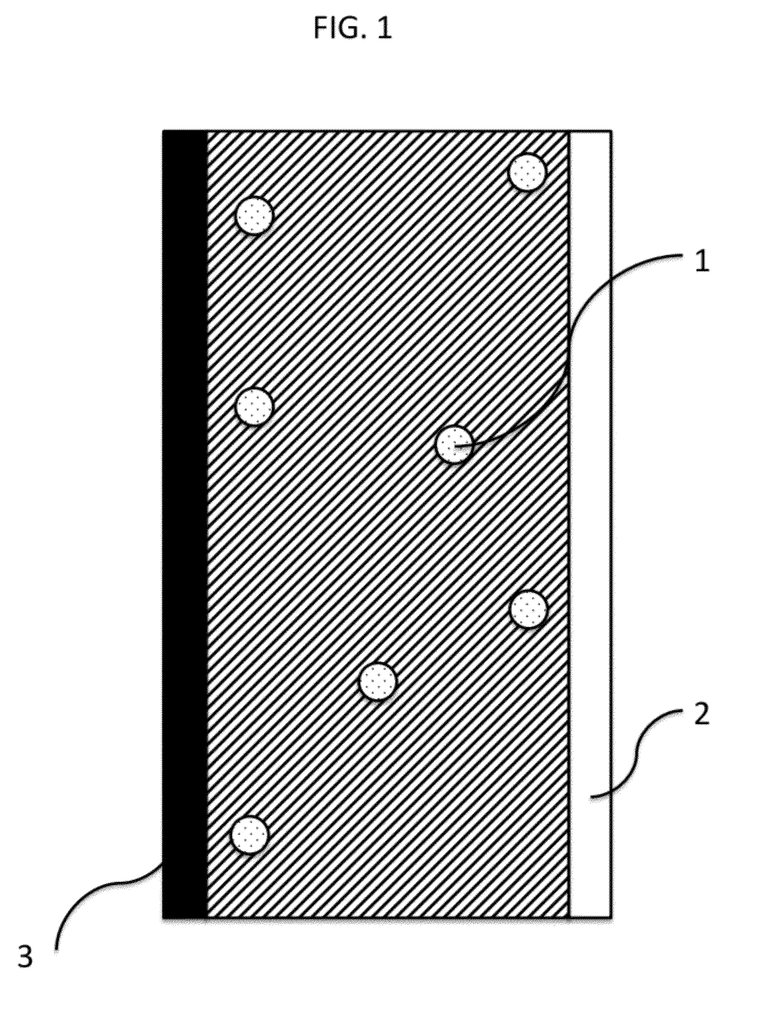

A schematic representation of the anode is shown in FIG. 1, the composite anode contains anode active material particles 1, and the composite anode attached on a current collector 3 is covered with an interfacial layer 2. The interfacial layer is a monolayer that covers at least 75% of the silicon composite anode surface with a more preferred coverage of over 95%. The interfacial layer is present in the anode active material in an amount ranging from about 0.001 to about 5 wt. % based on the total weight of the anode active material.

In connection with another embodiment of the present invention, an arrangement for use in a battery is implemented. The arrangement includes that the anode active material is mixed with carbonaceous materials and a polymer binder. The carbonaceous materials may be obtained from various sources, examples of which may include but not limited to petroleum pitches, coal tar pitches, petroleum cokes, flake coke, natural graphite, synthetic graphite, soft carbons, as well as other carbonaceous material that are known in the manufacture of prior art electrodes, although these sources are not elucidated here. The binder may be, but not limited to, polyvinylidene fluoride, sodium carboxymethyl cellulose, styrene-butadiene rubber, and etc. The mix comprising the anode active material, carbonaceous materials, and the binder can be applied to a current collector. The current collector can be, but not limited to, a metallic copper film with a preferred thickness of 10 micrometers to 100 micrometers. In this fashion, the arrangement can be used as an anode in a lithium secondary battery.

Consistent with one embodiment of the present invention, a lithium secondary battery is implemented with the anode, a cathode, a separator and a non-aqueous electrolyte. The cathode is comprised of active cathode materials, such as lithium manganese, lithium cobalt oxide, lithium ion phosphate compounds, and etcetera; carbonaceous materials, and a polymer binder. The non-aqueous electrolyte can be a mixture of a lithium compound and an organic carbonate solution. The lithium compound may be, but not limited to lithium hexafluorophosphate, lithium perchloride, lithium bix(oxatlato)borate, and etc. The separator membrane can be a multiple polymer membrane. The organic solution may be comprised of but not limited to any combination of the following species: ethylene carbonate, dimethyl carbonate, diethyl carbonate, propylene carbonate, vinylene carbonate, and etc.

In accordance with another embodiment of the present invention, the interfacial film can be coated on anode surface prior the anode being assembled in the lithium secondary battery; or the interfacial film can be deposited on anode surface after the anode being assembled in the lithium secondary battery via in-situ reaction through cell charging and discharging.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

While embodiments have been generally described, the following examples demonstrate particular embodiments in practice and advantage thereof. The examples are given by way of illustration only and are not intended to limit the specification or the claims in any manner. The following illustrates exemplary details as well as characteristics of such surface modified silicon particles as the active anode materials for lithium ion batteries.

In this example, 0.5 grams of silicon nanoparticles (average particle size below 100 nanometer) were well mixed with 0.5 grams of carbon black (average particle size below 50 nanometer), 3.5 grams of natural graphite (average particle size below 40 micrometer), and 10 milliliters 5 w.t. % polyvinylidene fluoride in n-methylpyrrolidone solution. The resulting mixture was applied to a copper foil (˜25 micrometer in thickness) via doctor blade method to deposit a layer of approximately 100 micrometers. The film was then dried in vacuum at 120 degree Celsius for 24 hours. The composite anode was coated by a polymer film by immersion in 2.5% n(acetylglycyl)-3-aminopropyltrimethoxysilane in methanol for 1 hour followed by rinsing with methanol. The anodes were then cured at 120 degree Celsius for 12 hours, and cooled to ambient temperature in vacuum.

The resulting anode coated with a polymer film assembled and evaluated as an anode in lithium secondary coin cell CR2032 with lithium metal as the other electrode. A disk of 1.86 cm² was punched from the film as the anode, and the anode active material weight is approximately 5 micrograms. The other electrode was a lithium metal disk with a thickness of 250 micrometers and had the same surface area as the anode. A microporous trilayer polymer membrane was used as separator between the two electrodes. Approximately 1 milliliter 1 molar LiPF₆ in a solvent mix comprising ethylene carbonate and dimethyl carbonate with 1:1 volume ratio was used as the electrolyte in the lithium cell. All above experiments were carried out in glove box system under an argon atmosphere with less then 1 part per million water and oxygen.

The assembled lithium coin cell was removed from the glove box and stored in ambient conditions for another 24 hours prior to testing. The coin cell was charged and discharged at a constant current of 0.5 mA, and the charge and discharge rate is approximately C/5 from 0.05 V to 1.5 V versus lithium for over 100 cycles.

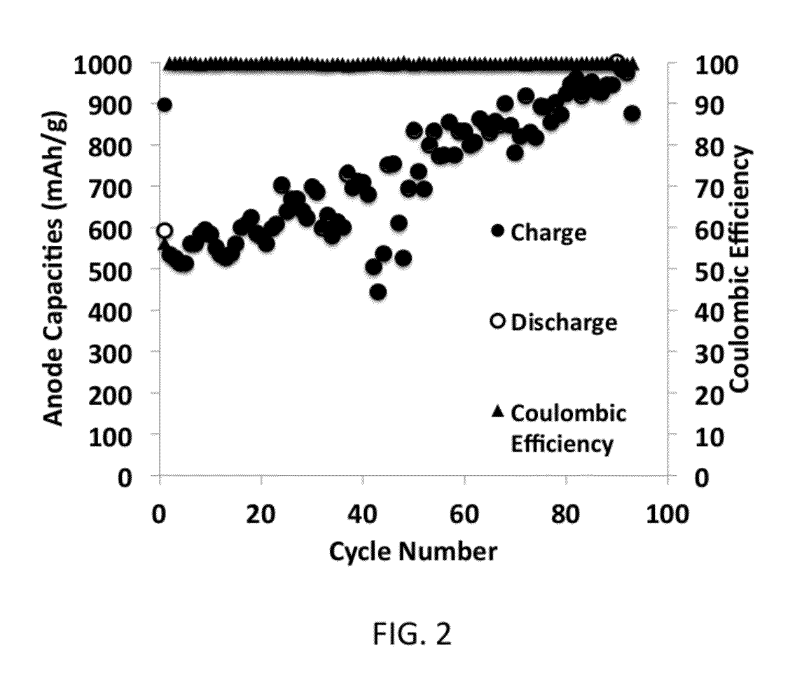

FIG. 2 shows the capacities of the sample anode over 100 charge and discharge cycles. Reversible capacity of over 800 mAh·g⁻¹ can be maintained after over 100 cycles with above 95% depth of discharge.

The preferred embodiment of the present invention has been disclosed and illustrated. The invention, however, is intended to be as broad as defined in the claims below. Those skilled in the art maybe able to study the preferred embodiments and identify other ways to practice the invention those are not exactly as described herein. It is the intent of the inventors that variations and equivalents of the invention are with in the scope of the claims below and the description, abstract and drawings are not to be used to limit the scope of the invention.

What the claim is:

1. A composite anode, comprising: a conductive current collector, an anode active material layer comprising at least one active material selected from the group consisting of carbon, silicon, germanium, tin, indium, gallium, aluminum, and boron; and an interfacial film coated on the anode active material layer.

2. The composite anode of claim 1, wherein the interfacial film is a polymer layer having composition of 10 to 100000 monomers, with a preferred composition of 100 to 10000 monomers. The monomer includes 1 to 20 functional groups per molecule and the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, an aryloxy group, or combinations thereof.

3. The composite anode of claim 1, wherein the interfacial layer having a composition of ligands directed bonded with the active anode layer surface. The ligands include 1 to 20 functional groups per molecule and the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, an aryloxy group, or combinations thereof.

4. The composite anode of claim 1, wherein the interfacial film has a thickness of 0.1 to 50 .mu.m, with a more preferred thickness of 0.5 to 10 .mu.m.

5. The composite anode of claim 1, wherein the interfacial film can be either created prior to anode assembly in a lithium secondary cell, or deposited during cell charge and discharge after anode assembly in a lithium secondary cell.

6. The composite anode of claim 1, wherein the anode active material layer includes at least one conductive agent selected from the group consisting of carbon black, graphite, carbon fiber, a conductive compound having a conjugated carbon-carbon double bond, and a conductive compound having conjugated carbon-nitrogen bond.

7. The composite anode of claim 1, wherein the anode active material layer further includes polymer binder selected from, but not limited to, the following materials: polyvinylidene fluoride, sodium carboxymethyl cellulose, styrene-butadiene rubber, or combinations thereof

8. A lithium secondary battery comprising: a non-aqueous electrolyte; a cathode comprising at least one cathode active material selected from the group consisting of lithium manganese oxide, lithium cobalt oxide, lithium ion phosphate; an anode active material layer comprising at least one active material selected from the group consisting of carbon, silicon, germanium, tin, indium, gallium, aluminum, and boron; and an interfacial film coated on the anode active material layer, and a separator disposed between the anode and the cathode for separating the anode and cathode from each other.

9. The lithium secondary battery of claim 8, wherein the interfacial layer is a polymer layer has a composition of 10 to 100000 monomers, with a preferred composition of 100 to 10000 monomers. The monomer includes 1 to 20 functional groups per molecule and the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, an aryloxy group, or combinations thereof.

10. The lithium secondary battery of claim 8, wherein the interfacial layer is a layer of ligands directed bonded with the active anode layer surface. The ligands include 1 to 20 functional groups per molecule and the functional groups are selected from the group consisting of an amide, an alkoxy, an acetoxy, an acryloxy, an alkyl group, a halogenoalkyl group, an alkylsiloxane group, an alkenyl group, a carbonyl group, a hydroxyl carbonyl group, an aryl group, an aryloxy group, or combinations thereof.

11. The lithium secondary battery of claim 8, wherein the interfacial film has a thickness of 0.5 to 50. mu.m, with a more preferred thickness of 1 to 10 .mu.m.

12. The lithium secondary battery of claim 8, wherein the interfacial film can be created prior to anode assembly in lithium secondary cell, or deposited during cell charging and discharging after anode assembly in lithium secondary cell.

13. The lithium secondary battery of claim 8, wherein the anode active material layer includes at least one conductive agent selected from the group consisting of carbon black, graphite, carbon fiber, a conductive compound having a conjugated carbon-carbon double bond, and a conductive compound having conjugated carbon-nitrogen bond.

14. The lithium secondary battery of claim 8, wherein the anode active material layer further includes at least a polymer binder, such as polyvinylidene fluoride, sodium carboxymethyl cellulose, styrene-butadiene rubber.
